(19) United States
(12) Patent Application Publication
(10) Pub. No.: US 2003/0224636 A1
(43) Pub. Date: Dec. 4, 2003

(54) Movable utility receptacle system

(76) Inventors: John F. Lorenzen, Beltsville, MD (US); Gary Lorenzen, Billings, MT (US)

Correspondence Address: Michael S. Neustel, Suite No. 4, 2534 South University Drive, Fargo, ND, 58103, US

(21) Appl. No.: 10/159,940

(22) Filed: May 29, 2002

(51) Int. Cl. H01R 25/00

(52) U.S. Cl. 439/110

(57) ABSTRACT

A movable utility receptacle system for providing multiple utilities within various convenient locations of a room. The movable utility receptacle system includes an elongate housing structure, a plurality of buses within the elongate housing structure, a cover member removably positionable over the housing structure, and a plurality of receptacles electrically connectable to the plurality of buses. The receptacles are comprised of a receptacle housing, at least one receptacle member and a plurality of receptacle prongs electrically connected to the receptacle member for electrically connected to one of the buses upon a desired location of the housing structure.

### CROSS REFERENCE TO RELATED DISCLOSURE DOCUMENT

This application specifically references and incorporates by reference Disclosure Document No. 503,438 filed on Dec. 11, 2001.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to building wiring systems and more specifically it relates to a movable utility receptacle system for providing multiple utilities within various convenient locations of a room.

2. Description of the Related Art

Conventional utility wiring systems for electricity, telephone, computer network and cable television have been in use for years. Conventional utility wiring systems utilize a length of wire/cable that is extended within the inside of a wall structure and then electrically connected to one or more receptacles within the wall at desired locations. The user is able to electrically connect various electronic appliances to the receptacles utilizing a conventional coupler.

The main problem with conventional utility wiring systems is that they cannot be easily adjusted to accommodate different room requirements. A further problem with conventional utility wiring systems is that they typically require the usage of extension cords and the like to reach desired outlets. Another problem with conventional utility wiring systems is that they are difficult to replace. A further problem with conventional utility wiring systems is that they are difficult to install within existing or new building structures. Various other well-known problems exist with conventional utility wiring systems.

Examples of patented devices which may be related to the present invention include U.S. Pat. No. 5,183,406 to Glen; U.S. Pat. No. 5,418,328 to Nadeau; U.S. Pat. No. 5,788,517 to Elmouchi; U.S. Pat. No. 3,012,217 to Pantin; U.S. Pat. No. 2,617,848 to Malone; U.S. Pat. No. 2,348,665 to Van Gehr; U.S. Pat. No. Re. 36,030 to Nadeau; U.S. Pat. No. 6,033,097 to Harwood; U.S. Pat. No. 5,688,132 to Rogers et al.; U.S. Pat. No. 3,559,149 to Shangena, Jr.; U.S. Pat. No. 3,166,370 to Parker; U.S. Pat. No. 2,942,224 to Messing; U.S. Pat. No. 2,924,804 to Frank et al.; and U.S. Pat. No. 2,261,986 to Frank et al.

While these devices may be suitable for the particular purpose to which they address, they are not as suitable for providing multiple utilities within various convenient locations of a room. Conventional utility wiring systems do not provide the required flexibility within a building structure to accommodate various room configurations.

In these respects, the movable utility receptacle system according to the present invention substantially departs from the conventional concepts and designs of the prior art, and in so doing provides an apparatus primarily developed for the purpose of providing multiple utilities within various convenient locations of a room.

### BRIEF SUMMARY OF THE INVENTION

In view of the foregoing disadvantages inherent in the known types of utility devices now present in the prior art, the present invention provides a new movable utility receptacle system construction wherein the same can be utilized for providing multiple utilities within various convenient locations of a room.

The general purpose of the present invention, which will be described subsequently in greater detail, is to provide a new movable utility receptacle system that has many of the advantages of the utility devices mentioned heretofore and many novel features that result in a new movable utility receptacle system which is not anticipated, rendered obvious, suggested, or even implied by any of the prior art utility devices, either alone or in any combination thereof.

To attain this, the present invention generally comprises an elongate housing structure, a plurality of buses within the elongate housing structure, a cover member removably positionable over the housing structure, and a plurality of receptacles electrically connectable to the plurality of buses. The receptacles are comprised of a receptacle housing, at least one receptacle member and a plurality of receptacle prongs electrically connected to the receptacle member for electrically connected to one of the buses upon a desired location of the housing structure.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a movable utility receptacle system that will overcome the shortcomings of the prior art devices.

A second object is to provide a movable utility receptacle system for providing multiple utilities within various convenient locations of a room.

Another object is to provide a movable utility receptacle system that allows for the connection of various utilities such as but not limited to electrical power, telephone, cable television, and computer network.

An additional object is to provide a movable utility receptacle system that may be easily installed within pre-existing or new building structures.

A further object is to provide a movable utility receptacle system that allows for the convenient repositioning of utility outlets about a room.

Another object is to provide a movable utility receptacle system that may be utilized within residential, commercial and various other building structures.

A further object is to provide a movable utility receptacle system that is easy and safe to install.

Another object is to provide a movable utility receptacle system that is comprised of a continuous structure that extends about the perimeter of a room.

A further object is to provide a movable utility receptacle system that places individual rooms upon a single respective circuit breaker.

Another object is to provide a movable utility receptacle system that may be utilized to rewire difficult to wire building structures such as older building structures and log homes.

A further object is to provide a movable utility receptacle system that may be customized to correspond aesthetically to various room designs and colors.

Another object is to provide a movable utility receptacle system that may be connected within various room shapes and sizes.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention fully assembled.

FIG. 2 is an end view of the present invention.

FIG. 3 is an end view of the housing structure.

FIG. 4 is a front view of the housing structure.

FIG. 5a is a front view of a telephone receptacle.

FIG. 5b is a front view of an electricity receptacle.

FIG. 5c is a front view of an Ethernet receptacle.

FIG. 5d is a front view of a cable television receptacle.

FIG. 6a is a side view of a telephone receptacle.

FIG. 6b is a side view of an electricity receptacle.

FIG. 6c is a side view of an Ethernet receptacle.

FIG. 6d is a side view of a cable television receptacle.

FIG. 7 is a front view of a receptacle housing having a plurality of receptacle members within.

FIG. 8a is a front view of an electricity straight joiner.

FIG. 8b is a side view of an electricity straight joiner.

FIG. 8c is an upper perspective view of an electricity straight joiner.

FIG. 9a is a top view of an inner corner joiner.

FIG. 9b is a top view of an outer corner joiner.

### DETAILED DESCRIPTION OF THE INVENTION

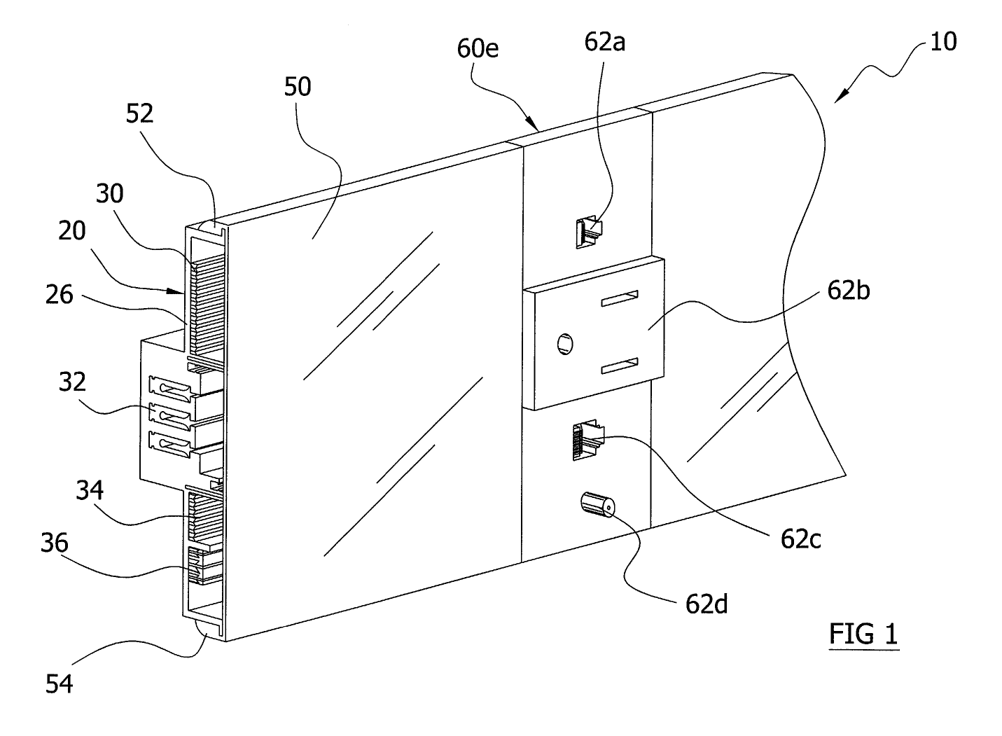

Turning now descriptively to the drawings, in which similar reference characters denote similar elements throughout the several views, FIGS. 1 through 9b illustrate a movable utility receptacle system 10, which comprises an elongate housing structure 20, a plurality of buses 30, 32, 34, 36 within the elongate housing structure 20, a cover member 50 removably positionable over the housing structure 20, and a plurality of receptacles electrically connectable to the plurality of buses 30, 32, 34, 36. The receptacles are comprised of a receptacle housing 60a-e, at least one receptacle member 62a-d and a plurality of receptacle prongs 64a-d electrically connected to the receptacle member 62a-d for electrically connected to one of the buses 30, 32, 34, 36 upon a desired location of the housing structure 20.

The housing structure 20 is comprised of an elongate structure that may have various pre-formed lengths. The housing structure 20 may be cut at various lengths to accommodate various room configurations of a building structure. The housing structure 20 may be comprised of various materials such as but not limited to plastic, vinyl, composite material, or metal. The housing structure 20 is preferably comprised of a material non-conductive of electricity and that provides an insulating barrier for electrical components. The housing structure 20 may be constructed to be mounted within a wall 12 as illustrated in FIG. 12, or directly to the outer surface of the wall 12.

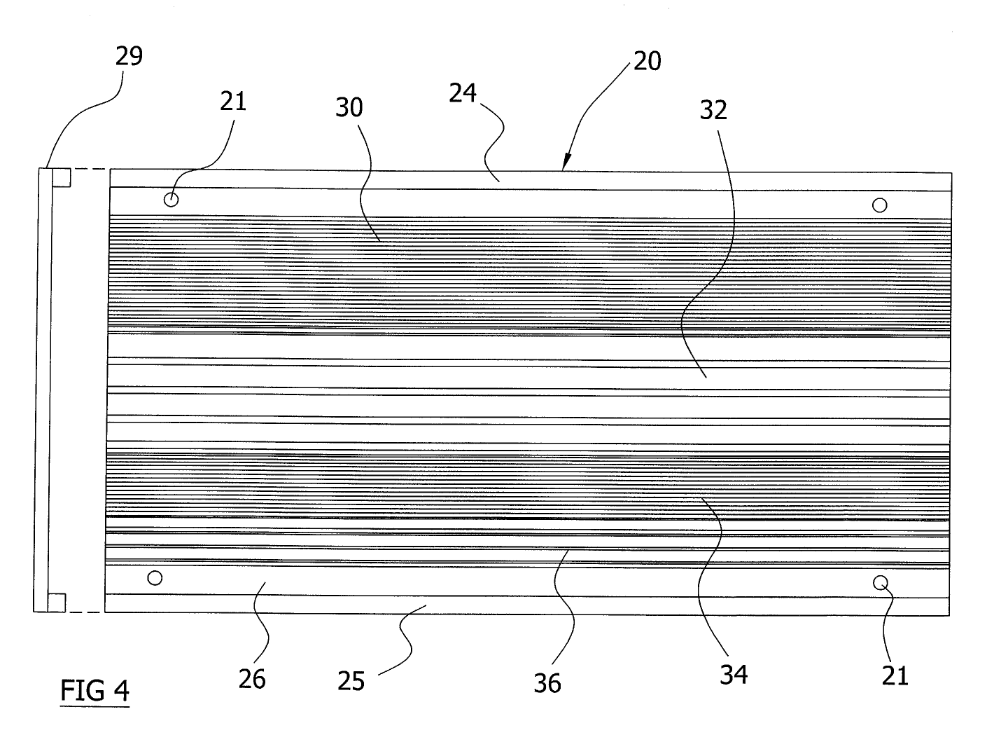

The housing structure 20 may be secured to a wall 12 utilizing various conventional fastening means such as but not limited to adhesive, hooks and fasteners. FIG. 4 illustrates the usage of apertures 21 extending through the housing structure 20 for receiving a corresponding number of fasteners that extend into the wall 12.

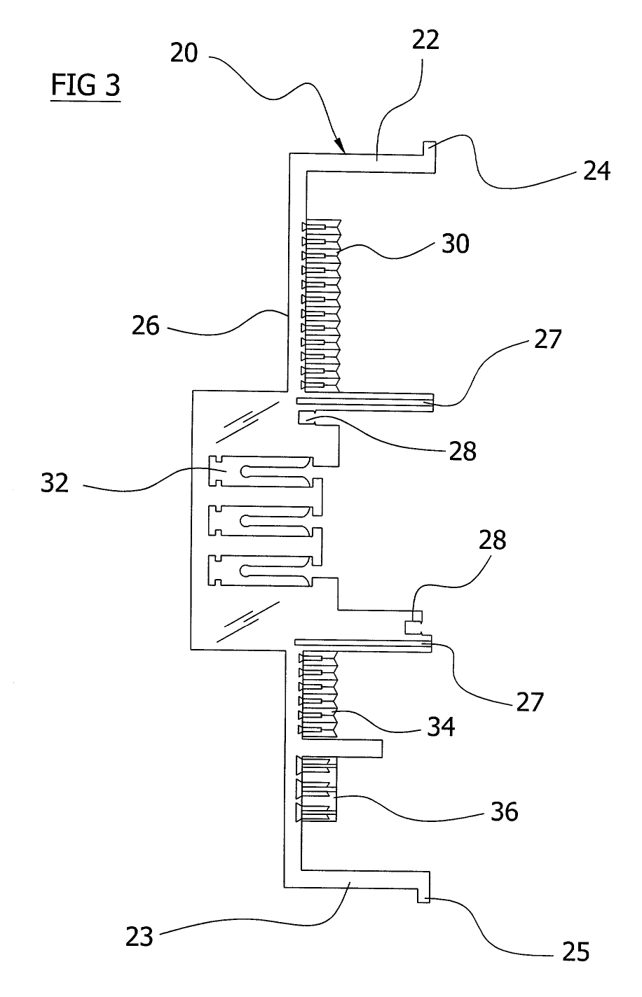

As best shown in FIG. 3 of the drawings, the housing structure 20 is preferably comprised of a rear portion 26, an upper portion 22 having an upper lip 24 extending from an upper edge of the rear portion 26, and a lower portion 23 having a lower lip 25 extending from a lower edge of the rear portion 26. The upper portion 22 and the lower portion 23 preferably extend parallel to one another and orthogonally from the rear portion 26 forming a U-shaped structure. The upper lip 24 and the lower lip 25 assist in maintaining the cover member 50 upon the housing structure 20. A cap member 29 may be attached to the exposed distal ends of the housing structure 20 for protecting the interior of the housing structure 20 as shown in FIG. 4 of the drawings.

As best shown in FIGS. 3 and 4 of the drawings, the housing structure 20 includes a plurality of buses 30, 32, 34, 36. Each of the buses 30, 32, 34, 36 correspond to a specific utility such as but not limited to telephone, electricity, cable television, and computer network. The buses 30, 32, 34, 36 preferably extend along the entire length of the housing structure 20 as shown in FIG. 4. Each of the buses 30, 32, 34, 36 has the desired number of bus receptacles depending upon the desired usage. For example, an electrical bus would have three bus receptacles. The bus receptacles are preferably comprised of a conventional frictional engagement structure commonly utilized that snugly receive the receptacle prongs 64a-d. An insulating structure preferably extends about the bus receptacles to separate each of the receptacles. The bus receptacles are then electrically connected to the desired utility at a specified location along the buses 30, 32, 34, 36.

As shown in FIGS. 1 through 4 of the drawings, a first bus 30, a second bus 32, a third bus 34, and a fourth bus are preferably positioned within the housing structure 20 from an upper segment to a lower segment of the housing structure 20 respectively. The first bus 30 is preferably comprised of a bus structure for telephone connections.

The second bus 32 is preferably comprised of a bus structure for electrical connections. The second bus 32 preferably includes a pair of opposing connector slots 28 for receiving a pair of corresponding connector members 66 from a receptacle housing 60a-e for securing the receptacle housing 60b containing the electrical receptacle member 62b. The connector slots 28 preferably include a pair of opposing inner flange members that catchably receive flanged distal ends of the connector members 66.

The third bus 34 is preferably comprised of a bus structure for computer network (i.e. Ethernet) connections. Finally, the fourth bus is preferably comprised of a bus structure for cable television connections. It can be appreciated that the respective positions of the buses 30, 32, 34, 36 illustrated may be switched around for various configurations not shown in the drawings. In addition, it can be appreciated that one or more buses 30, 32, 34, 36 may be utilized within the housing structure 20 depending upon the number of utilities utilized within a room. Each of the buses 30, 32, 34, 36 is electrically connected to the respective utility.

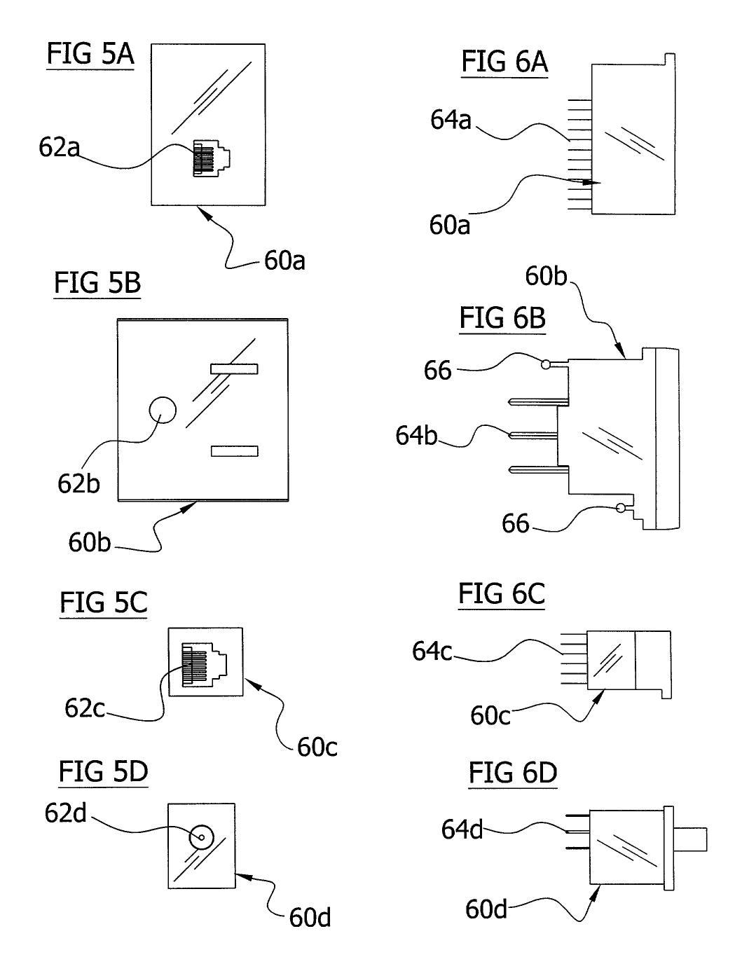

As shown in FIGS. 5a through 6d, the receptacles are comprised of a receptacle housing 60a-e, a receptacle member 62a-d and receptacle prongs 64a-d. The receptacle prongs 64a-d are electrically connected to the receptacle member 62a-d in an appropriate and predetermined configuration within the receptacle housing 60a-e. The receptacle prongs 64a-d extend from the receptacle housing 60a-e and are removably inserted within a corresponding bus 30, 32, 34, 36. The receptacle prongs 64a-d are preferably each comprised of a rigid straight structure that is removably received within the buses 30, 32, 34, 36.

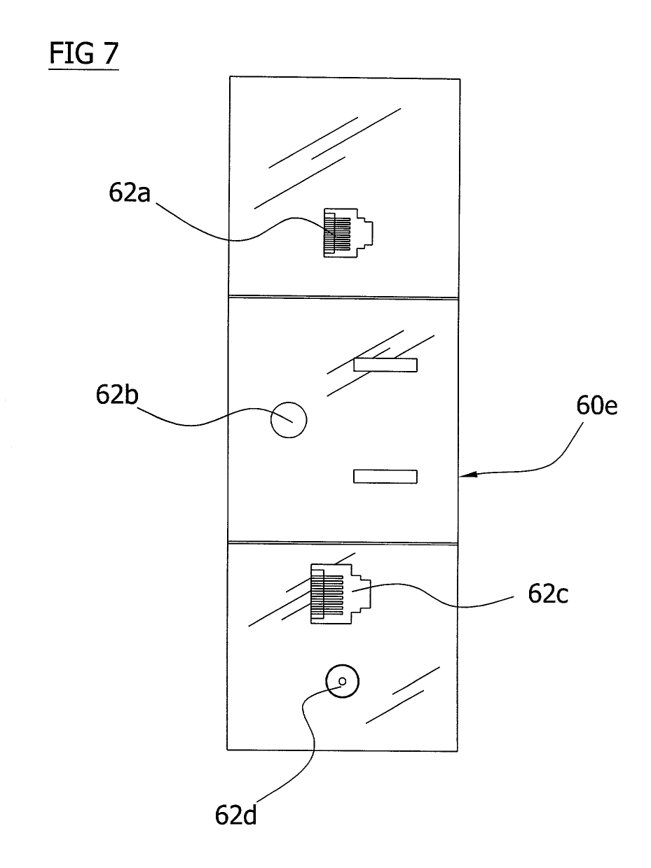

FIGS. 5a and 6a illustrate the usage of a telephone receptacle for electrically receiving a telephone cord plug. FIGS. 5b and 6b illustrate the usage of an electricity receptacle having a pair of connector members 66 extending parallel to the receptacle prongs 64a-d. The electricity receptacle is formed for electrically receiving a power plug. FIGS. 5c and 6c illustrate the usage of a computer network receptacle for electrically receiving an Ethernet plug. FIGS. 5d and 6d illustrate the usage of a cable television receptacle for electrically receiving a cable plug. FIG. 7 illustrates the usage of a single receptacle housing 60e for retaining a plurality of receptacles within a single receptacle housing 60e.

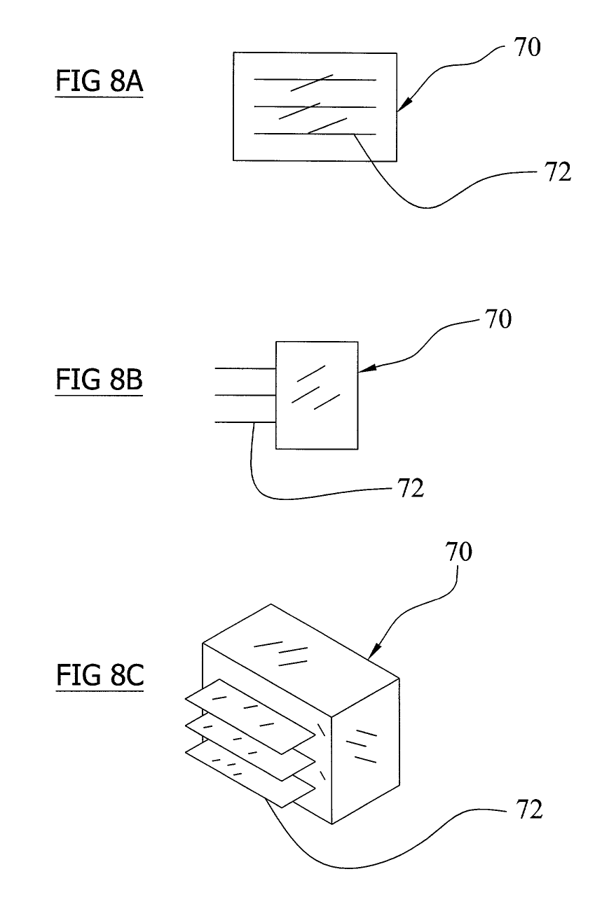

Since a plurality of housing structures 20 are typically required within a typical room, the housing structures 20 are positioned with their ends abutting one another and the buses 30, 32, 34, 36 electrically connected to one another by either a straight joiner 70, an inner corner joiner 74 or an outer corner joiner 76. The straight joiner 70 is comprised of a non-conductive housing having a plurality of straight joiner 70 prongs 72 that have a width sufficient for electrically extending between corresponding buses 30, 32, 34, 36 of each housing structure 20 as shown in FIGS. 8a through 8c.

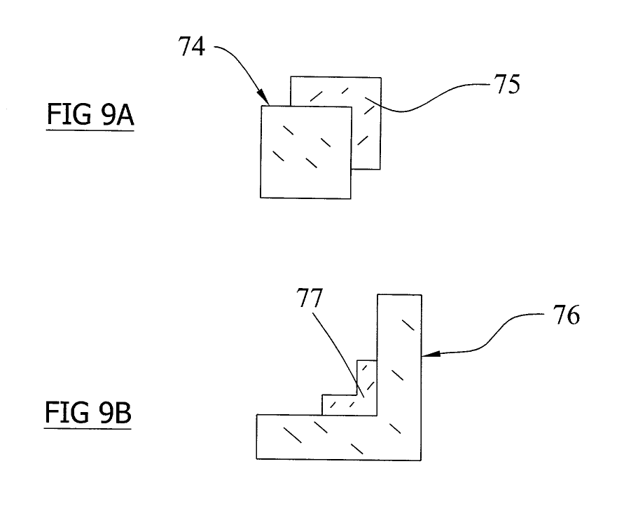

The inner corner joiner 74 is comprised of a non-conductive housing having a plurality of inner corner prongs 75 that have a width sufficient for electrically extending between corresponding buses 30, 32, 34, 36 of each housing structure 20 as shown in FIG. 9a of the drawings. The inner corner joiner 74 is formed for electrically connecting respective buses 30, 32, 34, 36 of a pair of abutting housing structures 20 having an abutment at an inner corner of a wall 12. FIG. 9a illustrates the inner corner prongs extending from two adjacent outer sides of the non-conductive housing.

The outer corner joiner 76 is comprised of a non-conductive housing having a plurality of outer corner prongs 77 that have a width sufficient for electrically extending between corresponding buses 30, 32, 34, 36 of each housing structure 20 as shown in FIG. 9b of the drawings. The outer corner joiner 76 is formed for electrically connecting respective buses 30, 32, 34, 36 of a pair of abutting housing structures 20 having an abutment at an outer comer of a wall 12. FIG. 9b illustrate the outer corner prongs extending from two adjacent inner sides of the non-conductive housing.

The cover member 50 is formed of an elongate structure that is removably attachable about the front of the housing structure 20 thereby enclosing the buses 30, 32, 34, 36 within the housing structure 20. The cover member 50 may be formed from various types of material including but not limited to plastic, vinyl, composite or metal. The cover member 50 preferably is comprised of an electrically non-conductive material. The cover member 50 may be cut to various lengths to fit between or about receptacles connected at various locations to the buses 30, 32, 34, 36.

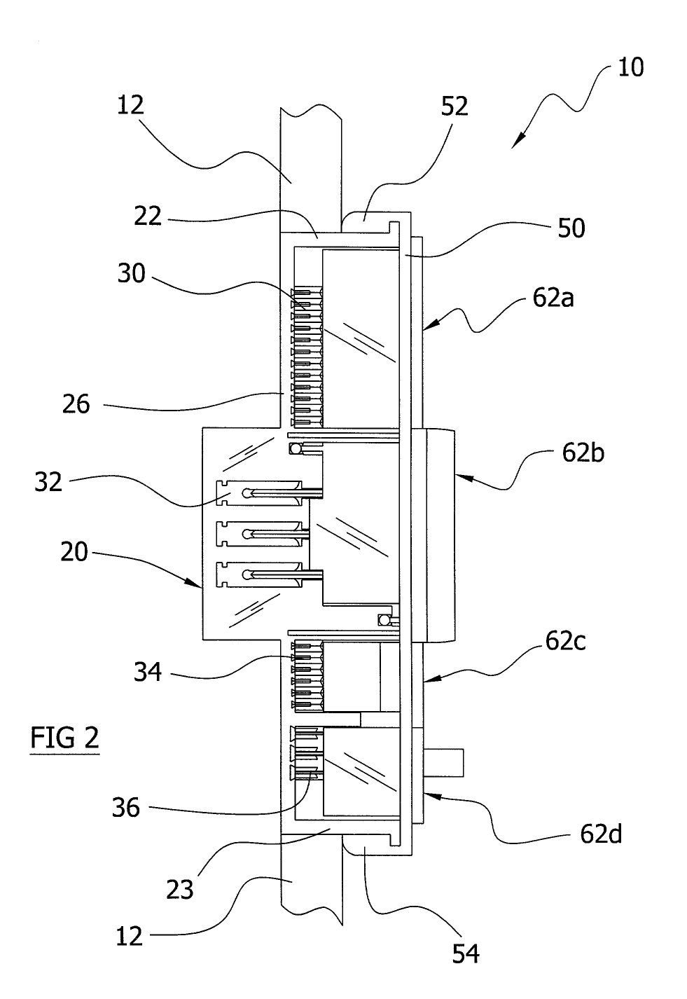

The cover member 50 preferably includes an upper cover portion 52 that has an upper slot that catchably receives the upper lip 24 of the housing structure 20 as shown in FIG. 2 of the drawings. The cover member 50 also preferably includes a lower cover portion 54 that has a lower slot in opposition to the upper slot that catchably receives the lower lip 25 of the housing structure 20 as shown in FIG. 2 of the drawings.

In use, the user secures a first housing structure 20 having a pre-cut structure to a first wall 12. The user then secures a second housing structure 20 adjacent to the first housing structure 20 upon a second wall 12. If a wall 12 requires more than one housing structure 20, the user simply secures the additional housing structure 20 to the wall 12 adjacent the prior housing structure 20. This process continues until the desired portion of the room has been covered with the housing structure 20. The user inserts the required jointer 70, 74, 76 to electrically connect the buses 30, 32, 34, 36 of the respective housing structures 20. The user further electrically connects the 30, 32, 34, 36 to a respective utility within the building structure such as but not limited to telephone wiring, electrical wiring, computer network wiring and cable television wiring. The user then determines the desired locations for specific receptacles and inserts the receptacle housing 60a-e within the housing structure 20 along with the corresponding receptacle prongs 64a-d electrically extending into the corresponding bus 30, 32, 34, 36. The user may connect one or more receptacle housings 60a-e at one or multiple locations in a stacked manner as shown in FIG. 1 of the drawings. The user then cuts the cover member 50 to a desired length to cover the housing structure 20 on opposing sides of the receptacle housing 60a-e inserted within the housing structure 20. The user continues this process until the desired amount of receptacles have been fully installed. The user may then plug-in the corresponding plugs within the receptacle members 62a-d as desired.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A movable utility receptacle system, comprising:
a housing structure having an elongate structure;
at least one bus within said housing structure; and
at least one receptacle removably positioned within said housing structure, wherein said at least one receptacle includes a plurality of receptacle prongs that are electrically connectable to said at least one bus.

2. The movable utility receptacle system of claim 1, including a cover member removably attachable to said housing structure.

3. The movable utility receptacle system of claim 1, wherein said housing structure comprises:
a rear portion;
an upper portion having an upper lip extending from an upper edge of said rear portion; and
a lower portion having a lower lip extending from a lower edge of said rear portion.

4. The movable utility receptacle system of claim 3, including a cover member having an upper cover portion removably engageable to said upper portion of said housing structure, and a lower cover portion removably engageable to said lower portion of said housing structure.

5. The movable utility receptacle system of claim 4, wherein said upper cover portion includes an upper slot for receiving said upper lip, and wherein said lower cover portion includes a lower slot for receiving said lower lip.

6. The movable utility receptacle system of claim 1, including a joiner for electrically connecting corresponding buses between adjacent housing structures.

7. The movable utility receptacle system of claim 6, wherein said joiner is comprised of a housing and a plurality of straight joiner prongs for connecting a pair of adjacent housing structures upon a straight wall.

8. The movable utility receptacle system of claim 6, wherein said joiner is comprised of a housing and a plurality of inner corner prongs for connecting a pair of adjacent housing structures upon an inner corner.

9. The movable utility receptacle system of claim 6, wherein said joiner is comprised of a housing and a plurality of outer corner prongs for connecting a pair of adjacent housing structures upon an outer corner.

10. The movable utility receptacle system of claim 1, wherein said at least one receptacle further includes a receptacle housing and a receptacle member.

11. A movable utility receptacle system, comprising:
a housing structure having an elongate structure;
at least one bus within said housing structure;
at least one receptacle removably positioned within said housing structure, wherein each of said at least one receptacle includes a receptacle housing, a receptacle member and a plurality of receptacle prongs that are electrically connectable to said at least one bus; and
a cover attached to said housing structure.

12. The movable utility receptacle system of claim 11, wherein said cover member is removably attachable to said housing structure.

13. The movable utility receptacle system of claim 11, wherein said housing structure comprises:
a rear portion;
an upper portion having an upper lip extending from an upper edge of said rear portion; and
a lower portion having a lower lip extending from a lower edge of said rear portion.

14. The movable utility receptacle system of claim 13, wherein said cover member includes an upper cover portion removably engageable to said upper portion of said housing structure, and a lower cover portion removably engageable to said lower portion of said housing structure.

15. The movable utility receptacle system of claim 14, wherein said upper cover portion includes an upper slot for receiving said upper lip, and wherein said lower cover portion includes a lower slot for receiving said lower lip.

16. The movable utility receptacle system of claim 11, including a joiner for electrically connecting corresponding buses between adjacent housing structures.

17. The movable utility receptacle system of claim 16, wherein said joiner is comprised of a housing and a plurality of straight joiner prongs for connecting a pair of adjacent housing structures upon a straight wall.

18. The movable utility receptacle system of claim 16, wherein said joiner is comprised of a housing and a plurality of inner corner prongs for connecting a pair of adjacent housing structures upon an inner corner.

19. The movable utility receptacle system of claim 16, wherein said joiner is comprised of a housing and a plurality of outer corner prongs for connecting a pair of adjacent housing structures upon an outer corner.

20. The movable utility receptacle system of claim 11, wherein said at least one receptacle further includes a receptacle housing and a receptacle member.
